(19) United States
(12) Patent Application Publication
(10) Pub. No.: US 2002/0198808 A1
(43) Pub. Date: Dec. 26, 2002

(54) Supply chain financing

(76) Inventor: James R. Myers, Bethesda, MD (US)

Correspondence Address: KILPATRICK STOCKTON LLP, 607 14TH STREET, N.W., SUITE 900, WASHINGTON, DC, 20005, US

(21) Appl. No.: 10/219,762

(22) Filed: Aug. 16, 2002

Related U.S. Application Data
(62) Division of application No. 09/368,422, filed on Aug. 5, 1999.
(60) Provisional application No. 60/095,422, filed on Aug. 5, 1998.

(51) Int. Cl. G06F 17/60

(52) U.S. Cl. 705/35

(57) ABSTRACT

The invention describes a method for financing and/or valuing participants in a supply chain. By aggregating borrowing needs of the supply chain, an individual participant in that supply chain may be able to obtain more favorable financing than if the borrower sought financing alone. This financing method may include credit scoring, credit enhancement techniques, and asset-backed securitization. A larger/stronger participant in the supply chain, which may even be the original equipment manufacturer itself, may support credit enhancement techniques. In return for such support, that larger/stronger participant may receive financial advantages and/or information as to how the participants operate and thereby be able to assist in managing the chain as a whole in a more efficient manner and thereby provide benefits to all participants in that chain.

### CROSS REFERENCE TO RELATED APPLICATION(S)

The present Application is a division of U.S. application Ser. No. 09/368,422, “Supply Chain Financing,” filed Aug. 5, 1999, which claims priority to U.S. Application Serial No. 60/095,422, “Supply Chain Financing,” filed Aug. 5, 1998, the disclosures of which are herein incorporated by reference in their entirety.

### FIELD OF THE INVENTION

The present invention relates to providing favorable financing to multiple key suppliers in a supply chain. The present invention also relates to the use of asset backed securities to finance portions of the borrowing needs to participants in a supply chain. The present invention also relates to using supplier information obtained as a result of such financing to assist in providing data inputs for data processing and to assist in the coordination and/or management of supply chain activities.

### BACKGROUND OF THE INVENTION

Suppliers are those companies or individuals who produce a good or service which is used by or incorporated into another product or service provided or made by either another supplier or an Original Equipment Manufacturer (“OEM”). A supplier does not provide this good or service to the end consumer of the good or service. Instead, the OEM supplies the goods or service directly to the consumer or indirectly to distributors/retailers which then provide the goods or service to the consumer. Direct suppliers provide their goods and/or services directly to the OEM while indirect suppliers provide goods and/or services to other suppliers who in turn supply goods and/or services to other suppliers or the OEM. Participants include everyone in this framework except the consumers.

FIG. 1 shows an example of how the suppliers 4a-4m are related to each other, the OEM 3, the distributors/retailers 2 and the consumers 1. Typically, the relationships are viewed as forming a pyramid with the consumers 1 at the top, the distributors/retailers 2 just beneath the consumers 1, the OEM 3 just beneath the distributors/retailers 2 and the suppliers 4a-4m branching out beneath the OEM 3. It should be noted that the relationships need not form a pyramid but rather it is the fact that goods and services are produced by participants at the lower parts of the structure and value is transferred up the structure to the next level.

Those participants at the bottom of the structure are referred to as indirect suppliers as their goods and/or services must go through another supplier before the goods and/or services ultimately arrive at the OEM 3. The participants directly beneath the OEM are direct suppliers as their goods and/or services go directly to the OEM. Thus, suppliers 4h-4m produce goods and/or services to suppliers 4d-4g who in turn produce goods and/or services to suppliers 4a-4c who in turn produce goods and/or services to OEM 3 who in turn produces goods and/or services to the distributors/retailers 2 who in turn provide the final goods and/or services to the consumers 1.

The relationships and transactions which begin at the bottom of the pyramid (for example with raw materials) and traverse the pyramid to the top (for example where goods and services are finished for sale and consumption) are referred to as a supply chain, a value chain or a value web. The “supply” comes from the fact that the lower level participants, usually indirect suppliers, provide or supply goods or services to the participants above them. Thus, supplier 4h supplies goods or services to supplier 4d who in turn supplies goods or services to supplier 4a who in turn supplies goods or services to OEM 3 who in turn supplies goods or services to distributors/retailers 2 who supply the final goods and/or services to the consumers 1. The “chain” comes from the fact that those goods and/or services that are provided by lower level suppliers cannot be passed to two levels above the level where the good or service is produced. Lower level suppliers typically do not skip a level to directly provide goods and/or services to suppliers or the OEM 3 two or more levels above themselves. Thus, if supplier 4d drops out of the chain, whatever goods or services 4h supplied to 4d typically are not used directly by 4a. In other words, every individual in the supply chain relies on those suppliers below him to provide a good or service that other suppliers or OEM 3 can use.

To better understand the above concepts, a particular simplified illustrative example is shown in FIG. 2. The actual relationships between suppliers are often much more extensive and complex, than these drawings portray. For example, an automobile manufacturer might be able to identify as many as several thousand suppliers in its supply chain. In FIG. 2, the consumers 1 give the distributors/retailers 2 money in exchange for cars. The OEM 3 produces the cars as finished products suitable for consumption and passes them along to distributors/retailers 2 in exchange for money. In order to make the cars, the OEM 3 needs labor, engines and tires, among other items. Supplier 4a supplies workers to assemble the cars in exchange for money and supplier 4b makes engines and supplies them to OEM 3 in exchange for money while supplier 4c makes tires and supplies them to OEM 3 in exchange for money. In order for supplier 4b to make the engines, it needs to receive steel to make the engine blocks, in exchange for money, from a steel producer 4f and fuel injection systems from supplier 4d. Similarly, in order for supplier 4c to make tires, it receives steel belts from steel processor 4f and prepared rubber from supplier 4e. In order for supplier 4d to supply fuel injection systems, it receives steel tubing from steel producer 4f and computer chips from computer chip manufacturer 4g. In order for the supplier 4e to supply processed rubber, it must receive raw rubber from a rubber tree farm 4h. In order for steel producer 4f to produce steel, it receives iron from mining companies 4i and 4j.

The structure in FIG. 2 shows how important each supplier is to the supply chain participants above it. For example, if the mining companies 4i and 4j delivered raw iron ore directly to engine maker 4b, the engine maker would be unable to produce engines. To the engine maker, the raw iron is practically without value unless there is a steel producer 4f present in the chain to turn the raw iron ore into usable steel. The relative inability for one supplier to jump over a supplier above it in the pyramid is just one factor of how important each supplier is in each supply chain. Thus, those suppliers and the OEM with suppliers underneath them are very interested in how those lower level suppliers operate because without them, the upper level suppliers and the OEM 3 would be either unable to operate or would operate in a much less efficient manner.

The above described supply chain system is useful yet it is inefficient for a variety of reasons. The first is underfinancing or undercapitalization of some participants within a supply chain. Many small and medium sized participants in supply chains are undercapitalized and lack the equipment, personnel and information technology resources to efficiently manage their internal operations. These undercapitalized small and medium sized participants find it very difficult to obtain financing for improvement and expansion, because lenders concentrate on factors such as past performance and the ability to repay in determining a participant's ability to borrow. These factors focus on the participant as an individual company without looking to additional profits or revenues resulting from future activities as a key supplier in a supply chain.

Participants with unfavorable credit ratings, often at the lowest levels of the chain, normally pay much higher interest rates to finance their operations than the OEM. To obtain financing as individual companies, these participants generally rely on the creditworthiness of each individual company (and sometimes of its investors as guarantors) while ignoring the participant's value to a supply chain. Thus, these participants often finance operations in a piecemeal fashion either by obtaining equity investments with various restrictions or by obtaining loans often secured with the borrower's plants, equipment, receivables, and other assets. The lending financial institution does not systematically take into account suppliers' importance to a supply chain.

Another problem with the system described above is the lack of uniformity many small to medium participants have in arranging financing for themselves. For example, since the participant is viewed as an individual, it may have different loans and other financial agreements with different financial institutions. Such a situation causes the participant to deal with a plurality of financial institutions for various dealings. This creates a money management burden on the participant and inefficiency due to a lack of consolidation.

Another problem with the system described above is the lack of education various participants receive regarding their roles in the supply chain. Since financial institutions view participants as individuals, participants tend to focus on their own concerns within their own corporate structure. Many participants view their financial concerns as strictly their own and this is an ineffective point of view since the value of the participant in the supply chain is ignored. Lenders and financial institutions do not generally assist borrowers in learning how to participate more effectively in their supply chains or by providing better credit ratings for those participants who are educated about the supply chain in which they participate.

Another problem with the system described above is the sharing of operational data between various participants. In the current environment, buyers and suppliers within a supply chain are often reluctant to share detailed financial and operating information with the companies they do business with directly. Rarely, can a supply chain participant obtain detailed and timely financial and operating information regarding the companies in their supply chain which they deal with indirectly.

Another problem with the system described above is the failure to provide advanced financing techniques to participants when they are viewed as part of the supply chain. The technology of issuing asset backed securities has grown rapidly in recent years yet such techniques, have not been used to finance groups of key suppliers in a supply chains.

### SUMMARY OF THE INVENTION

The present invention solves some of the problems described above by providing financing at favorable rates and on favorable terms often from a single lending source to the smaller or weaker participants which are part of a substantial chain of participants supplying goods or services to ultimate consumers.

In addition, the availability of a single lending source to finance the needs of small and medium participants in a supply chain provides advantages to the participants by providing flexibility, simplicity, lower borrowing costs, and growth opportunities over the system described above. The aggregation of borrowing needs from small and medium participants is advantageous to lenders and investors by providing opportunities for risk management through diversity, credit enhancement, and lower transaction costs per dollar borrowed.

The present invention combines aspects of the existing technology for issuing asset backed securities with credit enhancement techniques consisting of (1) selection of key or strategic suppliers which are participants in the supply chain identified as important to the future operations of the supply chain, (2) providing assurances, which may include long term purchase arrangements or participation in programs with a significant future term, to the lenders that such key or strategic participants will continue to participate in the supply chain, and/or (3) providing credit enhancement directly for the benefit of the investors in the asset backed securities such as by partial loan guarantees, purchase of a portion of such securities, backing loans with assets such as Treasury instruments, and/or participating in overcollateralization, tranching structures, and/or other methods.

The present invention also relates to using the provision of financing as a tool to obtain detailed financial and operating information from individual participants as borrowers so that other supply chain participants can more efficiently coordinate and/or manage the supply chain.

When strong and/or large participants in a supply chain agree to provide credit enhancement techniques in order to lower borrowing costs for a supply chain participant, then the borrower is required to provide detailed and timely financial and operating information in return. With such information, the strong and/or large participants have the opportunity to more efficiently coordinate or manage supply chain activities. By eliminating waste and inefficiency on the supply chain level, the supply chain can improve its overall profit margin, maintain lower prices to consumers, and reduce the risk of loan defaults and late payments by individual participant borrowers.

The present invention also relates to lowering the risk of default or late payment on an ongoing basis by participant borrowers through mechanisms such as: (1) requiring borrowers to participate in various training programs, initiatives, and educational activities designed to improve the borrowers' participation in their supply chains, and (2) financing capital improvement efforts designed to overcome internal inefficiencies and inadequate information technology.

Opportunities exist for lenders to lower their risks by requiring participant borrowers to receive ongoing training and education regarding the efficient functioning of their supply chain.

Such programs increase the opportunity for participant borrowers to identify problems faster and more efficiently, to obtain assistance from other supply chain participants, to avoid difficulties experienced by other supply chain participants, and to enhance the sales of participants to other supply chain participants.

Lenders in coordination with analysis by other supply chain participants can make intelligent decisions to provide additional capital to be used to address an individual supplier's internal systemic problems. Provision of such additional capital can result in lowering the risk of default or late payments by that participant borrower and also for the entire supply chain.

The present invention also relates to using advantageous financing to small and/or weak participants in supply chains where the financing is arranged by large and/or strong participants in return for economic benefits to both categories of participants. Small and/or weak participants obtain lower borrowing costs as well as capital for improvement and expansion.

Large and/or strong participants share in the financial rewards obtained by the small and/or weak participants in lower prices for goods and/or services provided to the large and/or strong participants as well as rebates or other financial concessions to the large and/or strong participants based on the increased rewards to the small and/or weak participants from increased capital for improvement and expansion.

Also, strong or large participants in the supply chain, such as large Original Equipment Manufacturers (OEMs), can organize and coordinate the participants in various supply chains beneath themselves to aggregate the borrowing needs for the supply chain and thus to enhance the overall creditworthiness of a supply chain.

### BRIEF DESCRIPTION OF THE DRAWINGS

FIG. 1 shows a supply chain structure.

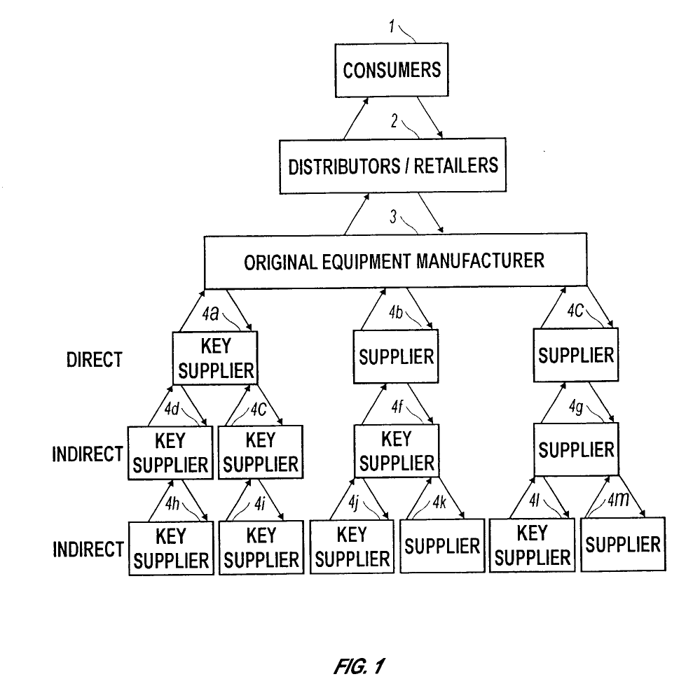

FIG. 2 shows a supply chain structure.

### DETAILED DESCRIPTION OF THE DRAWINGS

Traditionally, the Original Equipment Manufacturer (“OEM”) has cared about the goods and services it receives from its suppliers, both direct and indirect, but OEM have not assisted in the financing of an entire supply chain based on the importance of key suppliers. As noted earlier, a defective good or substandard service is carried up the chain through the OEM 3, the distributors/retailers 2 to the consumers 1, where it fails or performs inadequately. The consumer 1 then blames the OEM 3 even when the defective goods or services were produced at a low level of the supply chain.

While each supplier in the supply chain is valuable, not every supplier in the chain is highly valuable. Those suppliers/participants which are highly valuable are called “key.” Key suppliers are those who can significantly affect the productivity and prices of goods and services provided by the higher level suppliers and eventually the distributors/retailers 2 and OEM 3 above them. One method of discerning a key participant from a non-key participant is to measure the magnitude of the ripple caused by the actions (or disappearance) of the participant in question. In terms of pricing, a key participant who raises his prices for the goods and/or services he produces may will cause a proportional increase in the price of the goods and services of the supplier directly above him. This increase may travel, like a ripple on a still body of water, on up the supply chain perhaps even compounding in effect until the OEM 3 raises his prices to compensate for the OEM's increased cost in purchasing the goods and services from its suppliers. This increased cost is passed on to the distributors/retailers 2 which pass the increased cost along to the consumers 1 via higher prices. A non-key participant may not have this ripple effect or may be easily replaced.

Beyond pricing, many factors affect whether a supplier is key to the effective functioning of the of the supply chain. For example, quality is also a factor in determining which participants are key. A higher level supplier or OEM may value the quality of the goods or services provided by a lower level participant such that the higher level supplier or OEM is reluctant to go with another lower level participant (indirect supplier) which produces similar goods or services. This “loyalty from quality” comes from the fact that consumers, and to a certain extent the OEM, will most strongly remember a consumer good or service which fails to perform. For example, should an engine block crack due to low quality steel which was made from low quality iron ore, it is more likely than not that the consumer will remember the car manufacturer as the maker of bad cars even though the problem truly arose from mining company 1 who produced the low grade iron ore.

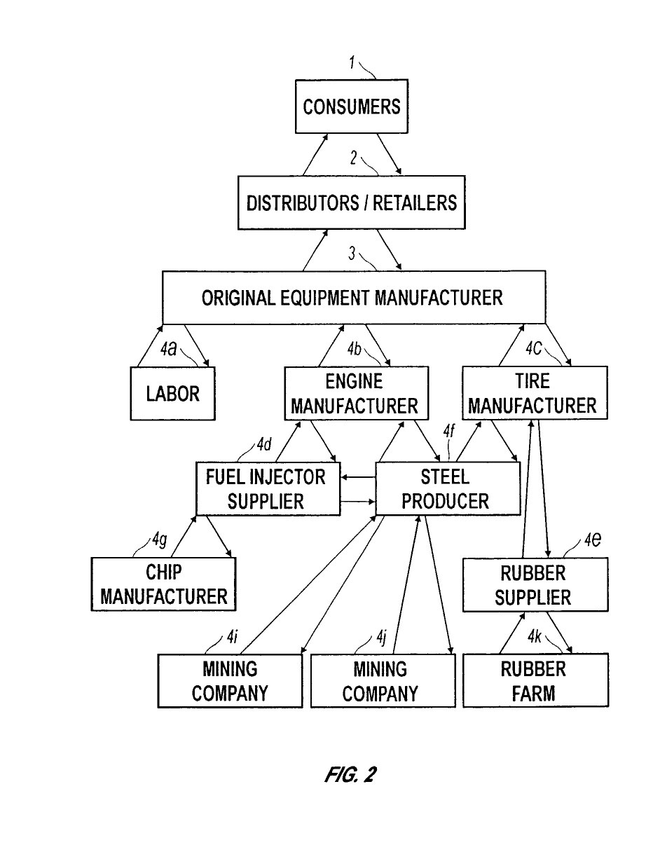

Another factor which goes into valuing suppliers in a supply chain is the number of companies in that market who are producing relatively similar quality goods for relatively similar prices. The extreme example in the opposite situation is the establishment of a monopoly within the supply chain. In FIG. 2, if there is only one tire manufacturer, then that tire manufacturer cannot be replaced easily. Situations which cause limited numbers of competitors include high barriers to entry, patent rights, government intervention and exceedingly high brand loyalty which makes it difficult for new suppliers to get market share. This relative difficulty in replacing one supplier with another is a factor which will cause the OEM 3 to rank the particular supplier as a key supplier. In the preferred embodiment, one or more strong and/or large participants in the supply chain select key or strategic participants in the supply chain. In order to make that determination, data related to the potential key or strategic participant needs to be gathered and calculated for a number of items across an extended time period such as the prices of items purchased, the delivery times, lead times, product cycles, mean time before failure, warranty claims, non-conforming deliveries, defects, profit margins, cash flows, economic value added, cash value added, labor productivity, capital productivity, net income, percentage of sales to supply chain, technology, innovation rate, innovation capability, and flexibility. In addition, each potential key or strategic participant needs to be benchmarked against other companies providing similar goods or services and so for each of the other companies essentially the same data needs to be gathered and calculated. Further, average values should be calculated for providers of the relevant goods and services. To reflect the needs of (direct and indirect) purchasers from the potential key or strategic participants and the importance of the good or service to the overall supply chain, a weighting of the factors needs to be identified for each good and service. The strong and/or large participants which provide direction, sponsorship and/or credit enhancement for the chain financing program would be responsible for establishing (or approving) this weighting of factors for each good and service to reflect the value to the supply chain. As previously noted, the data needs to be collected and calculated at regular intervals as the results can be expected to change over time. The past results and their trends can be used to forecast future performance, and management working at various participants in the supply chain can use the information as a diagnostic and as a guideline for remedial or improvement programs.

Given the large number of variables associated with determining what goods, services, and participants are key to the efficient operation of the supply chain, the use of a computer and associated software to make the mathematical calculations is a virtual necessity. Such calculations can be made using a personal computer such as a Dell Precision Workstation 610 operating Microsoft Windows NT and Microsoft Excel. Such calculations can also be performed on a wide variety of computers using a wide variety of software designed for mathematical and/or financial calculations. The goals of such calculations include identifying those participants which provide the greatest value to the chain and are the most difficult to replace, optimizing the structure of the supply chain by rewarding key participants, and optimizing the performance of the supply chain by identifying specific results, publishing those results within the supply chain, rewarding positive performance for specific behavior, and modifying participants' behavior to avoid unrewarded results and to encourage rewarded results.

One embodiment of the present invention solves the problems noted above. In particular, by using a preferred embodiment of the present invention, a lender's evaluation of a participant's ability to repay borrowings is enhanced. To determine a potential borrower's ability to repay, lenders generally analyze the supplier's credit score and the unique circumstances and payment history of the individual supplier. Creditworthiness is a characteristic of a business that makes that business likely to repay sums borrowed on terms agreed. Essentially the issue is the risk to the lender that the sums advanced to the borrower will not be paid back as agreed. Thus, the problem central to the issue of lending money or extending credit becomes one of risk estimation.

Credit scoring is based upon statistics. Over the years, financial institutions develop profiles of the people and companies they loan money to. For example, suppose a financial institution knows that 1 out of every 4 companies with less than 20 employees will default on their loans. If this were the only factor being used to assess the creditworthiness of a company, and the company had only 20 employees, that company would either get the loan at a higher interest rate or at increased fees, or may not even get the loan at all. Financial institutions keep statistics on a wide variety of data which are used to determine the statistical risk of issuing a particular loan to a particular borrower.

Credit scoring makes possible the assignment of a numerical measure of risk associated with each borrowing or extension of credit. With credit scoring a lender can assign a numerical value to the risk each applicant presents. Given the number of applicants, the size of the transactions, the need for consistency, speed and accuracy, and the number of variables analyzed, a computer using specialized software is a virtual necessity to perform the credit risk analysis associated with individual participants. Virtually no major financial institution in the United States extends significant credit or loans substantial sums on an ongoing basis without conducting some form of credit scoring, sometimes referred to as Operations Research or Operational Research, using computer software. In a preferred embodiment of the invention, the lender would use a credit scoring software package for lending to small and medium manufacturing companies developed by Fair, Isaac and Company.

Also, a lender can measure the level of risk to the lender associated with a package or portfolio of borrowings from different applicants and even in different sums. By determining the risk of each individual borrower, the lender may then look to the risk assigned to a plurality of borrowers. In a preferred embodiment of the present invention, a single lender would determine various participants' credit risk values and then combine, on a dollar-weighted average basis, these individual credit risk values into a numerical value associated with the credit risk for a specific borrowing for a supply chain. In this manner, the lender can evaluate the credit risk for each borrowing associated with a specific supply chain. Thus, an individual participant would receive favorable financing from a lender based on the credit scoring of the aggregation of borrowers, rather than on its own individual credit score. As noted earlier, the amount of complexity of calculations needed to determine the credit score of an individual participant is immense. It follows that multiplying these calculations for a plurality of participants in a supply chain increases the total complexity and time to determine a credit score for a supply chain. Thus, a computer using appropriate software (such as software package from Fair, Isaac and Company) would be used to determine the credit scoring for each borrowing associated with specific supply chain.

Beyond credit scoring, the financial institution may also evaluate the company's individual circumstances, including past performance. A company which has been late in paying its bills will probably be late in paying its bills in the future and this makes that company more of a credit risk. Conversely, a company which has routinely paid back its loans earlier than required is more likely to be viewed favorably by the financial institution. Additionally, a company with a significant backlog of purchase orders may receive more credit than a company without such a backlog.

A preferred embodiment of the present invention expands beyond these factors to determine the credit risk of a company. More particularly, a preferred embodiment also uses a participant's importance in its supply chain to evaluate the participant's credit risk. In accordance with a preferred embodiment of the present invention, three additional factors may be used (individually or in any combination) to evaluate a supplier's credit risk beyond credit scoring and individual circumstances. These additional factors are the largest/strongest participant's valuation of the participant seeking financing, the supply chain's importance to the largest/strongest participant, and any training which the participant seeking financing has gone (or maybe required to go) through which would make the participant seeking financing a better credit risk.

Determining the value of a large/strong participant places on a participant uses many of the same factors used to rank the participant as a key participant. As discussed earlier, how many others offer similar products and services will affect the value of that supplier to the largest/strongest participant. Referring back to FIG. 2, if there is only one tire supplier 4c, the value of that tire supplier 4c to the OEM 3 is quite high. Thus, the OEM 3 is likely to assign the tire supplier 4c a higher value than other suppliers and this valuation is then factor to be used to determine the participant's creditworthiness.

Similarly, the quality with which the participant supplies the goods and/or services will increase the value of that participant to the largest/strongest participant. A participant who delivers high quality goods and services is valuable to the largest/strongest participant because that high quality will be reflected in the final goods or service provided to the consumers 1. The largest/strongest participant values this particular participant for at least the reason that the largest/strongest participant's goods and/or services provided to the next participant up the chain or the consumers will be higher quality by incorporation of the high quality goods or service provided by the participant. The value the largest/strongest participant puts on such a participant due to the participant's high quality is a factor.

Another important factor is the price the largest/strongest participant pays the participant for the good or service render. A participant who offers goods or service at a lower price than another company is more likely to be more valuable to the largest/strongest participant for comparable goods and services.

Another factor is the timeliness in which the participant delivers its goods or services to another participant. A participant who is always on time with delivery and always delivers the correct amount of goods or services is likely to be more valued.

Having a participant provide high quality goods and/or services, at competitive prices and having that participant deliver those goods and/or service on a consistently timely fashion makes it easier and more efficient for the largest/strongest participant to operate. This increased efficiency, at a lower price will improve the largest/strongest participant's position in the market. Thus, the value each smaller/weaker participant gives to the largest/strongest participant in lower prices, efficiency and quality goes to improving the value of the largest/strongest participant's products provided to the consumers 1.

In another embodiment, the importance of the supply chain to the largest/strongest participant is used to enhance the creditworthiness of a supplier. As noted above, the participants provide value, in addition to goods and services, to the largest/strongest participant in a supply chain. The largest/strongest participant, in recognizing this value, places a value on the entire supply chain in which the smaller/weaker participant resides. This typically manifests itself through a promise from the largest/strongest participant to use that chain in the future. Contractual agreements which guarantee uses of the supply chain for a period of time tend to demonstrate to lenders that this chain, which includes the smaller/weaker participants, will be earning revenues for some significant period of time. By giving the smaller/weaker participant the assurance that this selected supply chain will be used by the largest/strongest participant, the smaller/weaker participant may take the largest/strongest participant's valuation and use it to enhance its creditworthiness with a lender.

In yet another embodiment of the present invention, the smaller/weaker participants use training programs to enhance their value in the supply chain and to the largest/strongest participant. Training may take on any of a number of forms such as quality control, management and even productivity seminars. Another form of education arises from the participant learning about supply chain economics and operations. The participant, when properly educated on the importance and preferred modes of supply chain operations, is more valuable and represents a lower credit risk. The participant begins to act in the interests of the entire supply chain, and maintains that chain in a stable prosperous manner, which is an important source of future income and growth. The six ongoing initiatives of the National initiative for Supply Chain Integration, Ltd. offer practical, experiential learning for supply chains working to improve themselves.

A securitization is a transaction in which a company issues securities for which the issuer is generally not corporately liable. The securities are backed by assets. In a preferred embodiment the assets would include written repayment obligations from suppliers who had borrowed sums as part of a chain financing program. Securitization allows an issuer to split into a variety of categories the risks and rewards associated with investing in a pool of assets such as receivables. The goal is to allocate the rewards to those market participants which will pay the highest price (or receive the lowest yield) for those rewards. Various categories of securities can be constructed so that the risks and rewards are allocated in an optimal fashion.

A key element in transactions involving asset backed securities is the credit enhancement associated with the structure. Credit enhancement is a source of capital built into every transaction as a cushion against losses. Losses occur when the borrower fails to pay back the loan as agreed including dilution risk (unrelated to creditworthiness of borrower and based on events such as disputes, returns, offsets, credits, rebates, warranty claims, etc.) and liquidity risk (for example, slow repayment). The purpose of credit enhancement is to make all or part of the asset backed securities attractive to investors. For example, investors are often interested in purchasing such securities when they have been rated. The market for asset backed securities is often a “triple A” market; asset backed securities are often rated in the highest rating category by at least one of the nationally recognized statistical rating agencies. Asset backed securities are also issued with other lower ratings, with a noninvestment grade, with an unrated designation or may be sold in private transactions. Rating agencies include Standard & Poor's (S&P), Moody's, Duff & Phelps, and Fitch Investor Services. From a rating agency's perspective, credit enhancement should be sufficient to cover a multiple of historical losses arising from a statistically similar previous pool. The multiple of coverage required by the rating agency will vary depending on the desired rating, the collateral being securitized, and the pool data available.

Traditionally credit enhancement techniques have been divided into two categories: external and internal. Examples of external credit enhancement include monoline insurance, corporate guarantees, letter of credit, and/or a cash collateral account. Monoline insurance is the most common technique. Monoline insurance companies include Municipal Bond Investors Assurance (MBIA), Financial Guaranty Insurance Co. (FGIC), Financial Security Assurance (FSA), or Capital Markets Assurance Corporation (CAPMAC). For a fee (either upfront or on-going) these companies insure cash flows from lower investment grade ratings to higher ratings (often “triple A”). For an insured AAA/Aaa rating, the insurer guarantees investors will be paid interest on a timely basis and principal will be repaid. Corporate guarantees protect investors from losses similar to insurance, but instead of insurance a corporation guarantees repayment obligations to upgrade the rating of the securities (for example, for the entire transaction or for specific classes of the securities). Normally, the corporation is guaranteeing repayment obligations for assets the corporation has generated such as receivables. A letter of credit is issued by a financial institution and guarantees the payment obligations. The rating of the asset backed securities cannot exceed the credit rating of the financial institution issuing the letter of credit. A cash collateral account is a loan to the issuer (usually a trust) of the asset backed securities where the loan is used to guarantee payment obligations and the loan amount can be paid down via excess spread from the transaction.

Internal credit enhancement techniques include senior-subordinated structures, overcollateralization, and spread accounts. In general, senior-subordinated credit structures are created with a single senior class and either a single or multiple subordinated classes. Such a structure can be designed to have different credit classes paid pro rata and/or sequentially with losses allocated first to the lowest junior class. An alternative senior-subordinated structure uses a shifting interest feature. Overcollateralization protects investors from losses by providing collateral with a repayment obligation in excess of the amount to be paid to investors. This excess collateral provides extra cash flow for payment of interest and principal, and thereby creates additional credit support for the benefit of investors. An alternative to overcollateralization is the use of a spread account where excess spread is accumulated as cash and reinvested as some short-term eligible investment.

Most asset backed securities are structured to combine external and internal credit enhancement. Credit enhancement decisions are generally based on relative costs. The issuer seeks to obtain the highest price (or give the lowest yield) with the lowest credit enhancement cost and risk. In addition to credit risk, asset backed securities are often structured so that securities present an attractive profile to investors regarding issues such as prepayment risk, average lives, principal windows and maturities. Time and prepayment tranches (such as coupon and volatility tranching) are often used to address these issues.

The present invention employs a combination of external and internal credit enhancement in a novel fashion. Corporate guarantees (or cash collateral accounts) from one or more large and/or strong borrowing participants in the supply chain for the repayment obligations of the smaller and/or weaker borrowing participants in that supply chain would provide external credit enhancement. Those same large and/or strong participants in the supply chain could also assist in internal credit enhancement by contributing to overcollateralization or spread accounts.

In a preferred embodiment, large and/or strong non-borrowing participants would participate in external, internal or combined credit enhancement techniques. In return for their participation in these credit enhancement techniques, the large and/or strong non-borrowing participants would receive either upfront fees or ongoing fees to compensate them for their risk. Given the large number of variables associated with structuring asset backed securities, the use of a computer and associated software to make the mathematical calculations is a virtual necessity. Such calculations can be made using a personal computer such as a Dell Precision Workstation 610 operating Microsoft Windows NT and Microsoft Excel. Such calculations can also be performed on a wide variety of computers using a wide variety of software designed for mathematical and/or financial calculations. The goals of such calculations include optimizing the structure to attract investors for the asset backed securities, reducing the borrowing costs to small and/or weak participants in the supply chain, and compensating the issuer and strong and/or large non-borrowing participants in the supply chain for the risks undertaken and the services provided.

In another preferred embodiment of the present invention, the largest/strongest participant receives valuable information from the smaller/weaker participants. Typically, each participant operates as its own unit in the supply chain. In this business method, each participant is generally looking out more for it's own interest than that of it's neighbors in the supply chain.

In accordance with a preferred embodiment of the present invention, a level of secrecy is maintained between the various participants in the supply chain. Simply put, day to day operational information is often kept from the others in chain. The largest/strongest participant is unaware of exactly how the other participants are doing business so it is unable to manage, coordinate, offer advice or provide assistance.

According to this embodiment of the present invention, the largest/strongest participant receives information from other participants regarding their operations. With this information, the largest/strongest participant is able to manage and/or coordinate supply chain operations at many levels.

The largest/strongest participant is able to receive information from various other borrowing participants and use the information as data inputs in data processing software to manage and/or coordinate supply chain activities. The method of the present invention values and manages the entire supply chain and provides the largest/strongest participant with enough information to make important decisions at various levels of the supply chain so the supply chain operates more efficiently.

In a preferred embodiment, the borrowing small and/or weak participants in the supply chain will provide detailed financial and operational information to the large and/or strong participants which are coordinating and/or managing the overall supply chain operations. As a condition of borrowing, borrowers regularly provide detailed financial and operating information to creditors and guarantors. In the present invention, that information can then be used efficiently to coordinate and manage the operation of the supply chain. One of the major barriers for participants in supply chain seeking to use software to plan and execute supply chain operations is inadequate (for example inaccurate and stale) data.

None of the current so-called “supply chain management software” is designed to facilitate coordination and/or management across the entire supply chain (for example multi-tier coordination from raw materials to ultimate consumer). Current supply chain management software is essentially of two types: supply chain planning software and supply chain execution software. The first type helps a company determine what to promise customers or which facilities to bring on-line. The second type of software helps a company to determine where a product is in the manufacturing stage. Manugistics and i2 Technologies have approximately 50% of the market share for supply chain software. In general, i2 Technologies has software designed for industrial manufacturing industries such as steel and high technology. Manugistics software has targeted applications for consumer goods companies. Other providers of supply chain management software include Logility, Aspen Technology, SynQuest and Numetrix. Supply chain software applications help companies forecast demand, manage production, and plot ideal distribution and transportation routes. Another type of prevalent software is enterprise resource planning (ERP) with primary providers being Oracle, Baan, SAP, and Peoplesoft. This ERP software helps with basic bookkeeping, order entry and accounting functions. These software products can be quite useful in identifying a problem, but can not assess the full impact of the problem and suggest a solution.

Software focused to provide specific solutions across three links or more in a supply chain is appearing. For example, Agile Software's “Workplace” supports definition, release, change control, and configuration management of specific Bills of Materials (BOMs), new product release data, and engineering change orders. By publishing BOMs via Java applications on the Internet and managing engineering change orders through Java applications on the Internet, a supply chain can readily manage some important cooperative activities. The ability to cooperate is becoming increasingly more important in supply chains, because more value-added product innovation, design, manufacturing, and content is being sourced outside the boundaries of individual OEMs into the supply chain (sometimes called “extended enterprise”).

Given the large number of variables associated with determining what goods, services, and participants are employed when, where, at what cost and in what combination to efficiently coordinate and/or manage supply chain activities, the use of a computer and associated software to make the mathematical calculations is a virtual necessity. A key to obtaining useful output from supply chain management software (however labeled or focused) is obtaining accurate, timely and useful input. This invention provides an essential step (accurate and timely data to input) so that software within a supply chain can provide useful output. With proper data collection, and input, the myriad of existing software products aimed at managing and coordinating supply chain activities can deliver more useful output.

While the above examples and descriptions have been provided for ease of understanding, they should not be construed to limit the invention as set forth in the appended claims. Obvious variations and modifications to one of ordinary skill in the art are within the scope of the present invention. For example, a supply chain may have multiple large/strong participants. Such a chain would be managed in accordance with the principles described above except that the decisions, asset backing and credit enhancement would potentially be divided amongst the plurality of large/strong participants in a manner suitable to the large/strong participants. In addition, the largest/strongest participant in a supply chain need not be the OEM. Through various factors, one of which could be the relative lack of competition a supplier has, a supplier, either direct or indirect, could become the strongest/largest participant in the supply chain. In addition, a strong/large participant may also receive rebates or credits from a small/weak participant which supplies goods and/or services to a competitor of the strong/large participant where the strong/large participant assists the small/weak participant using the methods described above in obtaining favorable financing. This situation demonstrates the profitability of the present invention. The small/weak participant receives the needed favorable financing. The competitor receives the goods and/or services it needs from the small/weak participant and the large/strong competitor receives rebates in its own supply chain for assisting the weak/small participant in a different and competitive supply chain.

What I claim is:

1. A method of doing business comprising:
an Original Equipment Manufacturer receiving information regarding supplier operations from both direct and indirect suppliers;
the direct suppliers and indirect suppliers receiving a value from the Original Equipment Manufacturer by participating in a favorable supply chain financing program; and
such information is used as data inputs for data processing to assist in the coordination and/or management of supply chain activities.

2. A method for a first supplier to coordinate supply chain activities, the method comprising:
receiving information regarding at least one direct supplier and at least one indirect supplier;
using the information as data inputs for data processing to assist in the coordination of supply chain activities; and
providing value for the benefit of the at least one direct supplier and the at least one indirect supplier in consideration of the participation of each benefited supplier in a supply chain financing program.

3. The method as in claim 2 further comprising:
assisting at least one benefited supplier to obtain favorable financing terms from a lender.

4. The method as in claim 3 further comprising:
providing information to a lender about at least one assisted supplier for the lender's use in making decisions.
